(19) United States
(12) Patent Application Publication
(10) Pub. No.: US 2003/0030666 A1
(43) Pub. Date: Feb. 13, 2003

(54) Intelligent adaptive navigation optimization

(76) Inventors: Amir Najmi, Menlo Park, CA (US); Ali Siddiqui, Fremont, CA (US)

Correspondence Address: ELLIOT B. ARONSON, 5001 HARBORD DRIVE, OAKLAND, CA, 94618

(21) Appl. No.: 09/923,916

(22) Filed: Aug. 7, 2001

(51) Int. Cl. G09G 5/00

(52) U.S. Cl. 345/745

(57) ABSTRACT

A method and apparatus for optimizing the navigation of lists or other hierarchies of alternatives, as presented to the user by electronic devices and computer networks, by automatically recommending the alternatives of the next list to be presented. Each alternative is recommended on the basis of the importance of that alternative to the user, or to the operator of the service provided to the user, or to providers of applications that can be selected by the user. The optimization is based upon probabilities estimated by mathematical functions on several variables, statistics, and parameters, including but not limited to the user location, time and date, user's expressed personal preferences, service operators' and application providers' expressed commercial intentions, service operators' and application providers' expressed business rules, implied application relationships, personal information of the user, usage statistics of the user, usage statistics of the general public, and embedded parameters which refine a statistical model of the user's behavior. Such optimization reduces the efforts required of a user to select one item, out of a structure of lists of items, by reorganizing the structure so that the user is likely to use fewer keystrokes or spoken words to select an item of combined higher importance to the user, the service operator, and the application provider. The optimization is personalized to each user by presenting the lists and structures to each user in a way that is automatically adapted to the statistical and deterministic factors pertaining to that individual user, so that users of different personalities and preferences can see or hear differently organized lists from which to choose. The number of keystrokes, or spoken words, is further reduced by intelligent data sharing between applications to avoid requiring the user's reentry of the same data to one application that was already entered in another.

### BACKGROUND OF THE INVENTION

The present invention relates to the intelligent sharing of data between, and navigation of, lists or other arrangements of alternative choices such as may be presented to a user on electronic devices such as a computer display monitor, a cellular telephone display, a PDA display, a wired telephone, or even specialized instrument panel displays. The invention is more particularly directed to optimization techniques for enabling the user to navigate through large numbers of choices to get to the selections that are relevant to the user, or to a provider of service to the user, more quickly and with less effort. The invention is more particularly directed, as well, to the intelligent sharing of data so as to reduce the user's effort in entering the data.

With advances in computer technology, wireless and wired networks, Internet connectivity, and database development, vast amounts of information have become readily available to users throughout the world, who are now also able to engage in various electronic actions such as sending and receiving messages over telephone or other messaging systems, sending and receiving faxes, and undertaking banking transactions, to mention just a few examples. Indeed, many business and individual users have become dependent on the availability of such information and the ability to engage in such actions.

As the demand for more and more computer-accessible information has increased, so has the development of search methodologies and data organization schemes that reduce the burden on the user to sort through this profusion of alternatives. Along with this the variety of business, consumer or other activities that may be undertaken electronically has also increased. In addition to the messaging, faxing and banking transactions referred to above, it is now common for example to make purchases on-line, to contact customer service centers, to trade in stock markets throughout the world on-line, or to engage in a number of less critical but more frequent tasks such as checking a basket ball score or finding a movie on-line. Accompanying the proliferation in information available and in transactions that may be undertaken electronically is the development of further devices capable of accessing information or engaging in electronic transactions—for example, personal digital assistants (PDAs), web-enabled cellular telephones, web-enabled automated teller machines (ATMs), and specialized electronic kiosks in retail outlets. Some of these devices have only limited display capability and the user is presented with lists of choices to scroll through. The limited display capability of many devices produces a bottleneck in reaching the desired information or action item.

A specific example from the world of Internet access by wireless telephone will illustrate the nature of this problem and will also illustrate the utility of the invention for internet-enabled wireless telephones, although as will become apparent below the invention has utility to a wide variety of other devices and computer networks. Cell phones typically include a small LCD screen for displaying the telephone number dialed as well as various messages and commands. For a cell phone that is equipped to access the Internet all information must be presented on the small screen. This is commonly done by presenting the user with lists of choices on the screen. At present, the wireless telephone market favors cell phones that are as tiny as possible without rendering the screens unreadable and the keyboards unusable. The tradeoff for minuteness is the inconvenience and discomfort experienced by the user in scrolling down long lists of alternatives that do not all fit on the tiny screen and in composing lengthy keystroke sequences on the tiny keypad or keyboard to navigate the Internet. This inconvenience and discomfort discourages many potential users from venturing onto the Internet over cell phones with the resultant effect of impeding the commercial development of the wireless Internet.

As a direct result of the market demand for cell phone miniaturization, a cell phone screen may be limited to only four items showing at any one time. With systems using the spoken word to list alternatives, the problem can be more severe because of the time required to carefully articulate each word in a long list. To select the desired item from a displayed list, the user must click on a key repeatedly to advance a pointer to the desired item. If the desired item is not one of the four visible at any time, the user must click on a scrolling button which in some cell phones displays the next four items. Should the user desire to select the last item of twenty alternatives, for instance, then four screen scroll clicks plus three advancing clicks plus a selection click, for a total of eight clicks, are required to select the item. Should that selection itself be a further list of items, the process must be repeated until the desired end destination is selected. So, for example, with only three levels of lists, the final selection might take as many as twenty-four clicks, by which time many users will have impatiently abandoned the chore. The experience for the user is very much more agreeable if the final choice is among the first four at the first or second level.

The sequence of a user's actions in advancing through a structure of alternatives presented electronically is commonly referred to as “navigation.” The general problem illustrated by the above cell phone example is the difficulty, inconvenience or tedium for a user to navigate through a complex of choices to find the target choice that provides the information the user seeks or that initiates the action the user desires to initiate. The problem is most severe with users of small electronic devices such as cell phones, PDAs, automated menus over manual touch-tone telephones, certain input devices to computer networks, automobile internal function selectors, or any of a number of other devices where items of the lists are spoken, or the display space is severely limited or typing is inconvenient. Although the problem is exacerbated in such limited electronic devices, the problem is nevertheless present in other settings as well, such as computer monitors having a much larger screen area for displaying information and full keyboards for data entry. Here the screen may provide the user with many choices at once in the form of screen buttons, icons, links or other hot spots, but more often than not the displayed choices contain many irrelevant ones, and the user is still called upon to navigate through a hierarchy of clicks to reach the target information or action.

A number of schemes have been devised to present information or action choices in a more meaningful way to more users. In some schemes the information or activities themselves are organized in categorical groupings believed to be meaningful, which are then arranged in hierarchical ways that are believed to provide access more quickly. Others call for collecting data on the individual user or having the user pre-select categories of potentially interesting information or activities and then using such information to customize the presentation to the user. Other schemes propose gathering statistics on prior usage and tailor the presentation based at least in part on the frequency of the user's past choices. While all of these approaches may have their respective advantages or benefits, they have not proven themselves sufficiently robust to eliminate the access bottleneck of limited-display devices as in internet-enabled cell phones and even in computers with comparatively large display screens have been only partially successful in reducing the level of difficulty in locating specific items within the totality of choices.

### SUMMARY OF THE INVENTION

The present invention provides a method and apparatus for presenting alternative choices to a user that greatly enhances the likelihood that the earliest choices presented will be highly relevant to the user or to a provider of service to the user. The methodology of the invention is particularly suited for use with electronic devices such as cell phones that have a limited display capability, typically only being able to display at most a relatively small, characteristic number of items to the user at a time, although the invention may also be used to advantage in connection with larger displays such as full-screen computer monitors. Although “display” is usually understood to mean visual display, as used herein it is used in a broader sense to include also aural and spoken communication of alternatives such as over a manual telephone or with voice-activation devices. Similarly, “selecting” as used herein is understood broadly to mean any manner of expressing a selection, including for example keystrokes, mouse clicks, touchscreen entries, as well as voice communication. It is a significant advantage of the invention that it appreciably reduces the access bottleneck inherent in devices with limited display capability.

It is an object of the invention to reduce the effort and inconvenience of navigation that a user faces in having to go through multiple layers of choices to find the sought-after end alternative. This is accomplished by reorganizing the structure of alternatives with the goal that the fewer the keystrokes, clicks or spoken words, required to select any particular alternative, the more likely the user is to select it. The invention accomplishes this objective by providing a statistical model that is adapted to transform an input structure having a first organization of alternative choices and generate a recommended structure having an organization of alternative choices in which the choices nearest the top of the structure will be relevant to the user's quest with a high probability. The statistical model is able to take into account such factors as the user's express preferences, the user's personal data such as age, gender, residence locality, occupation, and usage frequencies by the user, by the public in general, or by a similarly situated segment of the public. It is an advantage of the present invention that the statistical model is also able to take into account various other types of objective or subjective factors such as the subjective biases of the service operator or third-party advertisers as to what end alternatives the user is likely to search out.

Briefly, the statistical model computes an objective probability for each selectable end alternative, sometimes referred to herein as an “application,” according to the intended user's probability to select the application as modified by the commercial intentions expressed by the service operator and application provider. The intended probabilities are calculated by optimizing a certain function defining the statistical model referred to as the objective function. The optimization procedure takes into account the order of importance of each end alternative or application to the user, to the service operator, and to the application provider. It then “recommends” the next four items to be displayed, or spoken, depending upon their overall importance, so that the more important alternatives have a higher probability of selection by the user than the less important.

The recommendations are inferred by an optimization engine that statistically learns the tastes and choices of each individual user automatically, without the necessity of conscious effort by the user. The optimization engine then estimates the probabilities that the individual user might select each application and modifies those probabilities to account for the commercial intentions and biases that may be explicitly expressed by the service operator and by the application provider as well as by third-party providers such as advertisers. The estimating functions may use the statistics of the user's past selections, the user's explicitly stated preferences, the user's location, the time and date, the user's expressed preferences, the advertiser's expressed preferences, personal data known about the user, the usage statistics of the general public or of a similarly situated segment of the public, and the embedded parameters which refine a statistical model of the user's behavior. The invention optimizes the overall number of keystrokes or clicks required of the user in relationship to the probabilities of each alternative that the user will select it. Recommendations are made according to the overall optimization. In the cell phone example described above, the first four recommendations, at each step in the selection process, appear as the visible list displayed by the cell phone, thereby reducing the user's burden of time, effort, and inconvenience when accessing the Internet over the cell phone.

By way of example, the first list of alternatives might consist of the 31 items shown on some particular day on the home page of a popular web portal, which range from “Autos” to “Yellow Pages.” That ordering of lists may be acceptable on the full screen for which it was intended, but a similar ordering on a cell phone would require 31 clicks to select the 31^{st} entry, including the scrolling click after the fourth entry of each screen. By contrast, the optimized list of some particular businessperson, waiting in an airport, might first recommend the four items that are the most probable candidates for that businessperson to select at that time at that airport. They might be, for example, “Flights,” “Stock Quotes,” “Sports,” and “SMS” (Short Message Service, the cell phone equivalent to email). As another example, the four recommendations for a young lady on a midday shopping tour, might be “SMS,” “Beauty & Fashions,” “Restaurants,” and “Stock Quotes.” In either example, the item just selected might itself be a list. For instance, if a businessperson from San Francisco had selected “Sports” on a Sunday afternoon in football season, his or her next recommended list might be “Raiders Schedule,” “49er Schedule,” “Listen to Game,” “NFL.” Five clicks are needed to access the 49er schedule. Had the portal structure been used without optimization, the businessperson would have needed 26 clicks.

Several prior art personalized navigation systems are based upon explicit user inputs to the system in order to specify user preferences. In one form of prior art, initiated by Amazon.com, users of the web site are invited to explicitly choose the kind of advertisement or application they prefer to invoke, conditioned upon the advertisement or application they are viewing at the moment. In another form of prior art, popular in web portals such as AOL, Yahoo, and Excite, users are invited to select which alternatives they prefer to see on the home screen of the portal. In still another form of prior art, for example in Microsoft Word, users are invited to express their preferences by clicking on dozens of items in lists of options provided by the application. For example, they may prefer blue background with white text to white background and black text. Common to this prior art is the need for the user to explicitly state fixed preferences in order to personalize the application or portal. The personalization can be changed by the user at any time, but between these explicit changes of the user the personalized presentation is fixed and remains constant. Such personalized navigation schemes have no inherent software or hardware intelligence to automatically adapt to new or changing circumstances.

Unlike these prior art schemes, the statistical formulations of the invention are particularly important because fixed user preferences that are originated or modified only by the user, or some other person, cannot accurately personalize an electronic device or computer network for each individual user. The information to be personalized can change quickly and without notice, for example the frequent and unending introduction of new web sites on Internet. In addition to changes in the user's electronic environment, each user's personal tastes can change quickly and without notice. For example a sudden change in the stock market might motivate some users to review their stock portfolios more often during a period of flux, then less often during a period of stability. Any automatically adapting personalization of navigational alternatives must be based upon usage statistics of some form in order to accurately estimate the items of interest during periods of introduction or change. Statistical analysis is required because no single sample of a user's choices can be expected to accurately predict the user's next choice. The statistics of the invention are required for accurate, up to date, personalization, and they are uniquely accurate in their predictions. Although the recommendations of the optimization engine of the invention are based upon uniquely accurate statistics, they are further influenced by the other factors, such as location, date, etc., mentioned above. Those other factors serve two purposes. First, they more accurately define the personal context of the user, and therefore the more appropriate statistics. Second, they introduce new possibilities that may not have a high probability of choice simply because the user is unaware of them. Third, they allow the operator of the wireless service to suggest alternatives which may be equally acceptable to the user, but more acceptable to the operator of the service.

The invention further reduces the user's effort after the user has selected the desired alternative. The application software invoked by the user's final selection may request information that the user has not yet provided to that application. For example, a user of a cell phone might order a taxicab. The application of the taxicab company might ask the user for the address of the pick up. The address can be uncomfortably lengthy to enter by the user, especially on a limited device such as a cell phone. However, it is sometimes likely that the requested information was already provided by the user to some other application that was invoked by the user in making some previous selection. For example, the user of the cell phone might have already made reservations at a restaurant and, before leaving the restaurant, then called a taxicab to arrange a pickup at the restaurant. Furthermore, it may be that the previously evoked application shares no data with the requesting application. In the example, the restaurant has no arrangements for sharing data with the taxicab company. In such cases, the invention can match the type of data object requested by the requesting application with data objects previously recorded or passed through the device to the other applications. According to the invention, likely matches can be displayed in such a way that the user can select one of the alternatives displayed. The complete data represented by the selected alternative can then be provided to the requesting application as if provided directly by the user. In the example, the address of the restaurant is provided to the service operator, by the restaurant, as part of the Internet site data. The taxicab application, in requesting an address, triggers an action by the apparatus of the invention to display other likely address objects for the user to chose from. The restaurant is a likely address in this situation and therefore appears as a likely alternative. In the example, the cell phone user selects the restaurant address, rather than entering it character by character, thereby significantly reducing the effort of the user to enter the address of the restaurant. This further reduction of the user's effort, by the invention, is significant because a single keystroke of the user can sometimes replace tens of keystrokes to enter the entire address.

The service operator and the application provider must be able to define the variables and parameters which influence the user's selection of any item, and to define the forms that the user must fill-in to use a particular service or application. The invention provides a control panel and an Application Programming Interface (API) to assist in the development of services and applications which use the invention.

Thus, it is an overall advantage of the invention that it does not merely weight alternatives according to pre-set probabilities, either fixed or conditional, or according to pre-set incidence matrices incorporating pre-established rules, but rather the resulting order in any recommended tree or other data structure is dynamic, readily changing and changeable in response to a large number of pre-determined or real-time influences as readily updated by optimizing the objective function. In one aspect of the invention the statistical model is an Empirical Bayes model that is particularly suited for taking into account a wide variety of objective and subjective criteria in determining the recommended organizational structure for the alternatives choices.

Other aspects, advantages, and novel features of the invention are described below or will be readily apparent to those skilled in the art from the following specifications and drawings of illustrative embodiments.

### BRIEF DESCRIPTION OF THE DRAWINGS

FIG. 1 is a high-level block diagram of an illustrative system according to the invention for use with an internet-enabled cellular telephone system.

FIG. 2 is a tree diagram showing a portion of a generic tree.

FIG. 3 is an expanded view of a cell phone display screen showing a list of alternatives.

FIG. 4 is a tree diagram showing a portion of a recommended tree.

FIG. 5 is a tree diagram showing a correlation list.

FIG. 6 is a diagram showing an initializing correlation matrix.

FIG. 7 is a data flow diagram showing the major object classes for an implementation of the invention.

### DETAILED DESCRIPTION OF ILLUSTRATIVE EMBODIMENTS

For purposes of illustration an embodiment of the invention is described in connection with an internet-enabled cellular telephone system. This system is offered only by way of example and no limitation to cellular telephone systems or to systems operating over the Internet is thus intended. By way of terminology the entity that provides for access to the Internet over the telephones is referred to herein as the service operator, or sometimes simply the operator. In commercial reality the service operator may consist of two or more companies cooperating to make Internet service available to cell phone users, and such are referred to here collectively as the operator. In other environments the operator will generally be the entity or cooperating entities that are responsible for giving users of the system access to a multitude of applications from which to choose, which access may be provided over the internet or over other networks or systems depending upon the particular environment at issue. The subscribers to the service are generally referred here as users.

FIG. 1 shows an overview of the system. The user enters the system through cell phone 10. Keystrokes, sometimes called “clicks,” are conducted by the cell phone network through a communication server 11 of the service operator to server-side middleware, generally referred to here as the platform 12 and generally hosted by the operator. The platform communicates with Internet server 13 for establishing connection to the Internet indicated generally at reference numeral 14.

The intelligent navigation optimization and intelligent data sharing of the present invention is provided here by a scenario manager 16, which in turn comprises an optimization engine 17, context processor 18, and database server 19. All information used by the scenario manager is obtained from platform 12, cached in database 19, processed, and returned to the platform. The platform is responsible for passing the processed information through communication server 11 to cell phone 10 or through Internet server 13 to the application provider at its web site, ftp site, email mailbox or other internet contact address. The application provider likewise responds to the platform middleware, and thus to the scenario manager, through the Internet and Internet server. The sequence of transactions that take place between the user on cell phone 10 and the application server on Internet is referred to here as a scenario. All data that remains constant during a scenario is updated to and from database 19 and platform 12 in an off-line mode, so called because the user whose data is being updated need not be on-line during the update. In practice, the off-line mode is in reality a background mode because at least some users are almost always on-line in a foreground mode. Within scenario manager 16 context processor 18 provides an electronic-intelligence engine that interprets context information for the optimization engine. For example, if a user has directly declared or implicitly shown a preference for Italian restaurants, and that user subsequently searches for restaurants on the Internet, the optimization engine will cause Italian restaurants to appear with greater ranking.

Transformations of Trees

Optimization engine 17 serves to transform a generic tree of alternatives into a recommended tree that optimally represents the preferences, statistics, location, and other factors of each user as may be adjusted to reflect the commercial biases of the service operators and application providers. Although the recommended tree and generic tree are referred to and described in the illustrative examples as trees, in fact the invention applies to other hierarchical data structures as well. Those skilled in the art, given the benefit of the tree structures provided herein, will readily be able to apply the invention to other hierarchical structures. For example, the invention may be applied to any structure that is composed of ordered lists. A tree is commonly understood to be the specific case of a graph that has no cycles, that is to say, no loops that can be traced by following some path through the structure. In fact, the structures transformed by the invention in many real situations are more likely to have cycles than not. Nevertheless, for descriptive simplicity and visual clarity, all examples are presented here as trees.

The applications are placed in the recommended tree according to their intended probability of selection, and not solely according to the probability of selection based upon past usage, because the scenario manager may adjust those probabilities according to commercial biases expressed by the service operators and application providers. The commercial biases cause the optimization engine to improve the positioning of an application in the tree beyond that based solely on the user's past selection history, so that the operator or application provider may engage in commercial advertising, promotions, and other commercially valuable activities that benefit from such improved positioning. However, the improved position does raise the probability that the user will select it because users are more likely to select applications requiring fewer keystrokes. Therefore, the recommended tree does correspond to a ranking according to the probability of the user's selection, although the commercial intentions, not just the user past selections, influence that probability.

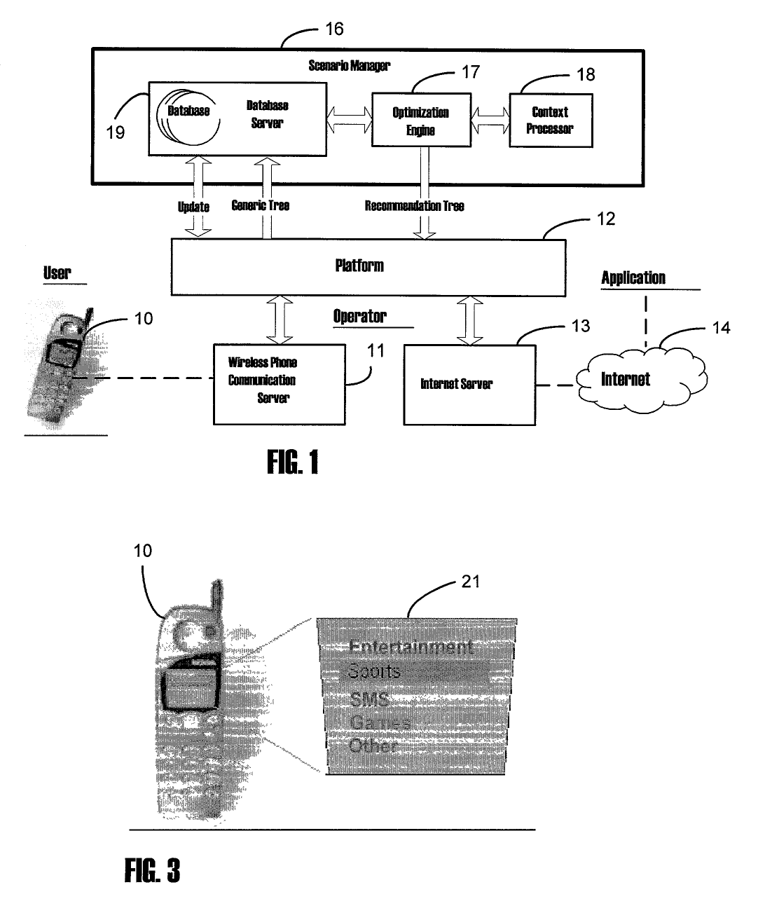

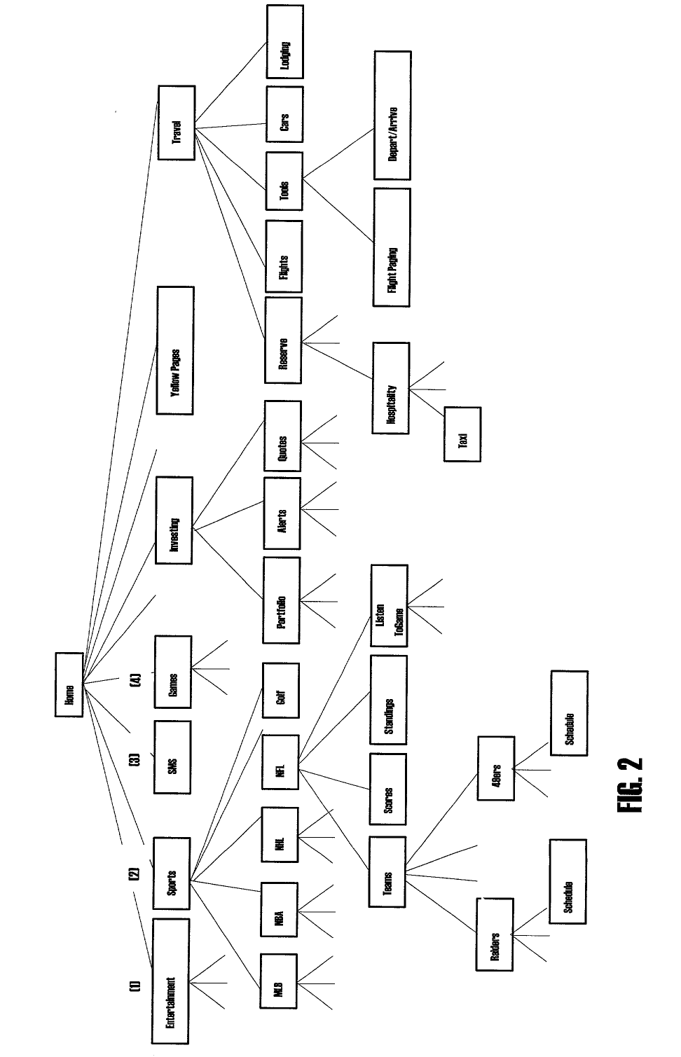

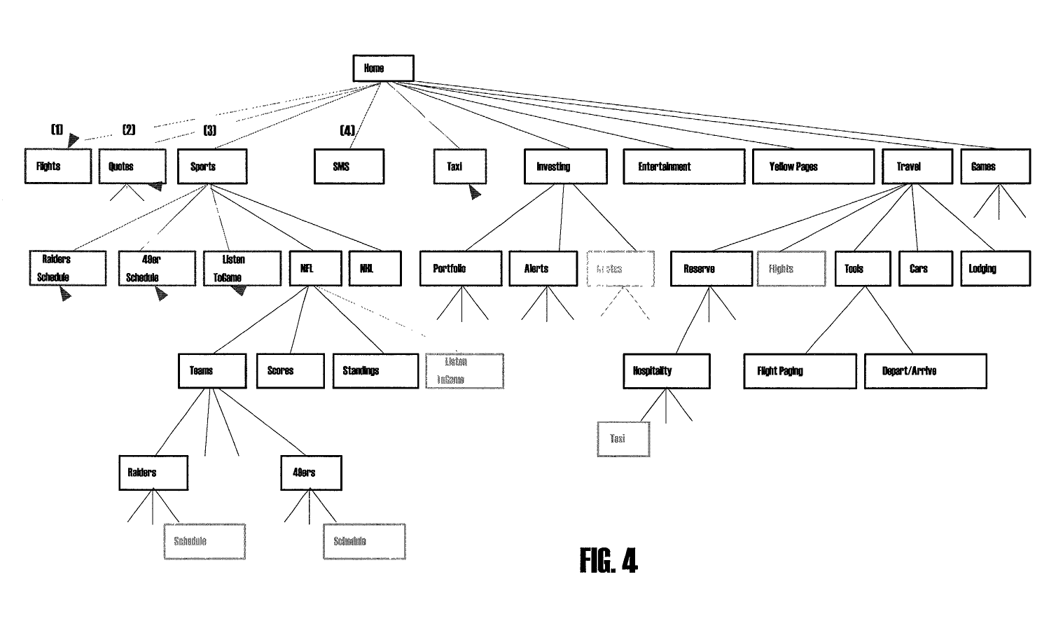

The generic tree is provided by platform 12 and encompasses all alternatives offered by the service operator to the user. It is totally lacking in personalization for any one user. FIG. 2 shows an example of a generic tree modeled after the home page of the Excite Internet portal. The totality of choices available through the Excite home page is quite large and is organized as a complex graph structure. For purposes of illustration, only a few elements are shown here and these are represented as a tree. For example, the lists of alternatives appearing in just the “Explore Excite” block of the home page has 63 items. With only four display lines on the cell phone, sixteen scrolling keystrokes would be required to view all 63 alternatives. An abbreviated list first displayed to the cell phone user might contain for example only the items: “Entertainment,” “Sports,” “SMS,” “Games,” “Investing,” “Yellow Pages,” and “Travel,” in that order. (See FIG. 2.) The top to bottom ordering of the cell phone is represented as left to right in the Figures showing a tree (FIGS. 2, 4, 5). The numbering in parentheses in FIG. 2 shows the first four items on the display 21 of cell phone 10 in FIG. 3, where the designation (1) indicates the top item and (4) indicates the bottom item. Each of the items of the first row of FIG. 2 when clicked will show another list represented as the next level in the tree. For example, clicking on “Travel” will produce the list: “Reserve,” “Flights,” “Tools,” “Cars,” and “Lodging.” Subsequently clicking on “Tools” will produce “Flight Paging” and “Depart/Arrive.”Subsequently clicking on any one of those will produce the list corresponding to that item, and so on to whatever depth is appropriate for that particular path through the tree. The application appears as the end alternative in the path through the tree. When an application is reached, it assumes control and provides its own displays rather than the lists provided by the invention.

Distance to the End Alternative

The limited display capability of the typical cell phone is illustrated in FIG. 3. The cell phone display 21 shows five lines of display, four of which are available to show four alternative choices, that is, four nodes of the tree, to the user at a time, and the fifth of which is reserved for scrolling to the next four nodes. In general, the invention is particularly useful with electronic devices such as the cell phone illustrated here that have a display capable of showing only a small characteristic number of alternative choices to the user at a time. For extremely small devices such as a wristwatch-based computer the characteristic number of alternatives may only be one or two, while the characteristic number may be larger for intelligent instrument control panels of the type that make a number of control and maintenance functions available to a user. In the cell phone example of FIG. 3 only the first four items on any list can appear on the display. In this example, the first four at the top level are: “Entertainment,” “Sports,” “SMS,” “Games,” and “Other”. The cell phone includes a means for indicating which item on the list is being pointed to by the user. In FIG. 3 the pointer appears as a highlighting of the Sports item. Should the user select the item pointed to, the next list that will appear is seen from FIG. 2 to be: NBA, MLB, NHL, NFL in that order. To select NFL, the user must click the pointer down to MLB, then to NHL, then to NFL, then to select, for a total of four clicks. The number of clicks needed to select a given end alternative, that is, a leaf at the end of a path through the tree, is taken here as a measure of the distance of the end alternative and is referred to as the distance or sometimes as the click length of the given end alternative. The distance of the i^{th} application is sometimes indicated here by the symbol dᵢ, which is a positive integer. The distance depends on the structure of the tree (or more generally on the graph structure) as well as on the size of the display, that is, the characteristic number of alternatives that can be simultaneously displayed.

Reordering and Promoting

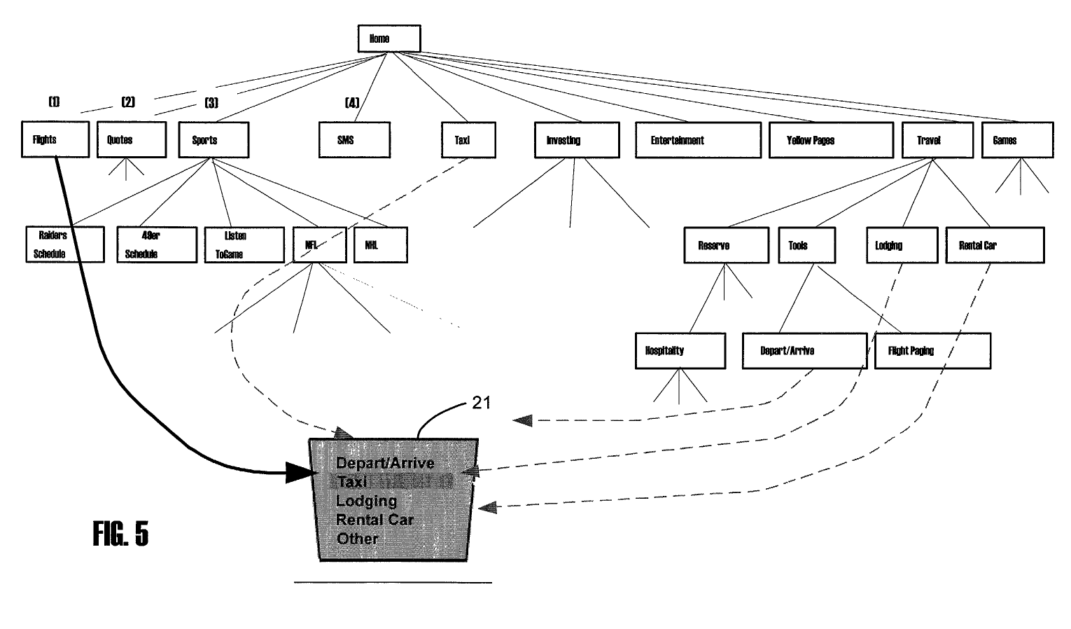

The intended probability of each item in the structure is determined by several functions of several independent parameters, variables, and statistics. The optimization engine begins the recommendation process by accessing the generic tree from the platform. Some preliminary transformations may be made on the tree by the segmenting, grouping, and business-rules processing in accord with the invention, as described hereinbelow, to produce a reduced generic tree. The optimization engine obtains the recommended tree by applying an optimizing transformation to the reduced generic tree. The optimizing transformation consists of the evaluation of several functions as described hereinbelow. One effect of these transformations is to reorder the items in a list to place the intended most probable items at the proportionately shortest distance. Another effect is to promote items to a higher level in the tree. An example appears in FIG. 4. The example of FIG. 2 has been subjected to promotion and reordering transformations according to the intended probability of selection by the user. The probability is determined by the commercial biases of the operator and application provider as well as the particular user's personal probability of selecting the end alternative. Comparison of FIG. 4 to FIG. 2 shows that the first item, “Flights,” was promoted from the “Travel” list, “Quotes” was promoted from the “Investing” list, and the three items “Sports,” “SMS,” and “Investing” were reordered ahead of “Entertainment” at the first level. The “Taxi,” “Raiders Schedule,” and “49er Schedule” applications were each promoted three levels rather than one. All were reordered with respect to each other and ahead of several other preexisting entries. The optimization engine provides the recommended tree to the platform on demand for the next list to display. The platform then generates and manages the actual display.

When an alternative is promoted, it is placed in the list above it at a higher-order position than the current list. It will also generally be removed from its current list when it is promoted, although in some embodiments it may be desirable to leave a copy of the promoted alternative in its previous position perhaps grayed out if it is desired to keep track of alternatives' previous positions. For example, in FIG. 4 the “Listen to Game” application was promoted to the same level as “NFL,” but to an ordering just before “NFL,” and it was removed from the list “NFL.” An application can undergo several promotions in the course of any one optimization.

Optimizing the Objective Function

The optimization engine arrives at the recommended tree by optimizing a particular function referred to herein as the objective function. This function depends on a number of parameters and variables that may relate to characteristics of the user, of the applications or application providers, of the operator, or even of third parties such as third-party advertisers. The objective function will also generally include certain parameters that may be referred to as scaling parameters and that are available to be adjusted, typically empirically, to fine tune the results. The specific mathematical form of the objective function and the specific parameters, parameter values, and variables on which it depends represent a statistical balancing of many weighting factors to determine an optimized structure for the recommended tree. A particular objective function together with its parameters and variables are referred to generally as a statistical model. Various factors already suggested above that may be taken into account by any given statistical model include the user's express preferences, the user's personal data such as age, gender, residence locality, occupation, and usage frequencies by the user, by the public in general, or by a similarly situated segment of the public. It is an advantage of the present invention that the statistical modeling approach espoused here also enables various other types of generally subjective factors to be readily taken into account such as the subjective biases of the operator or third-party advertisers as to what the user wants to see or what the operator subjectively feels or objectively calculates will bring the highest revenues to the operator. That is, through the statistical model the recommended outcome may be weighted by a wide variety of user-specific and non-user-specific data as well as objective and subjective preferences. A statistical model may also readily allow for the likelihood that such end alternatives as individual addresses or telephone numbers or other individual data items may be high on the recommended list. The objective function is generally optimized by finding values of the relevant variables that produce a local maximum of the objective function (or local minimum depending on the particular objective function).

A description is now given of a statistical model. The optimization engine accesses the generic tree from platform 12 and retrieves any relevant usage statistics of the user or of other usage groups from database 19. In any practical implementation the generic tree and other data may actually be retrieved from a cache memory instead of directly from a stored database. The particulars of any particular hardware implementation are not germane to the invention, and all such implementations are understood to be included when references are made to exchange of data with platform 12, database 19, or any other components discussed herein. These statistics are initialized to some initializing values provided by the optimization engine. They are then recalculated by the optimization engine at appropriate times and updated in database 19. The usage statistics of a given individual user is represented by μᵢ , where μ is the estimated mean number of times that the user selected application i in a given time interval τ. The time interval τ is a parameter of the statistical model according to the invention. Although a single time interval τ is utilized here for all applications, in fact different time intervals could be used that might be more appropriate for particular applications or that might be correlated with other parameters. The particular value of τ is not significant for purposes of the present example. The invention may in fact use different values of τ to obtain different behaviors of the optimization engine.

The calculation of μᵢ may advantageously use one of the Empirical Bayes formulations of most likely estimators. When an Empirical Bayes estimator is used, the statistical model is referred to as an Empirical Bayesian statistical model. In such cases the calculation takes into account both the mean calculated over the entire population of users who subscribe to the services of the given operator as well as the mean for the individual user. The Empirical Bayes estimator can be calculated by several generally known methods. The invention may use several different methods for different situations. One method that may be used in the invention is known as the James-Stein Estimator. Moreover, it may sometimes be advantageous not to use an Empirical Bayes estimator at all, but rather to use another method not relying on Empirical Bayes statistics; for example, where overall computational speed is of great importance a non-Empirical Bayes method may yield higher throughput. The individual means for each application and each user represent usage statistics that are stored in the database by the optimization engine. The database is generally updated in background mode.

Having estimated μᵢ, by whatever the method, the optimization engine then calculates the user's propensity, bᵢ, an estimate of the probable frequency with which the given user would select the i^{th} application were the generic tree to be flat. That is to say, bᵢ represents the intrinsic propensity of the user to select the i^{th} alternative as if the tree had presented all applications at exactly the same distance so that distance had no influence over the user's choice. Although the value of bᵢ, cannot be known directly, it can be inferred from the set of μᵢ collected for the user, along with the distance variables stored in the platform database as an attribute of each μᵢ. The inference requires a reconstruction of each past optimization preceding the current optimization. From that reconstruction the bᵢ can be inferred for each user for each of the i^{th} applications. Thus, the general purpose of computing μᵢ is to infer bᵢ.

The presence of one other variable, vᵢ, is especially advantageous in the optimization process. It is a weighting factor that may represent the objective or subjective commercial bias of the service operator, application provider or third-party advertiser with respect to the i^{th} application. The value of vᵢ is generally set by the service operator and may be taken for example as a measure of the perceived dollar value of a user selecting the i^{th} application, although other principles could also be used to set the value of vᵢ. The perceived dollar value, or the measure in general, may be entirely subjective or may be based on the outcome of an objective financial model or other model.

The Objective Function is an optimizing function chosen for its desirable properties. Other functions than that illustrated here may also be used, which may yield different weights that may be more appropriate for example in other environments where optimization engine may have different objectives from the present example. The Objective Function in the present example is:

Σvᵢbᵢe^{-λdi} Expression 1

The exponential coefficient λ is a scaling parameter of the particular statistical model of the invention. As the behavior of users, and the modeling of that behavior, becomes better understood with use, this parameter is permitted to evolve to fine-tune the model. Furthermore, other statistical models could by used, in which case other parameters may be involved. The values of the variables bᵢ are initially set according to the business rules entered by the service operator. The subsequent values of the variables bᵢ are then calculated from the μᵢ reconstructing the previous trees by successively applying Expression 2, for each i and solving for each bᵢ. to yield

μᵢ=bᵢe^{-λdi} Expression 2

The next recommended tree is then constructed by optimizing the Objective Function of Expression 1 for all applications, thereby defining the dᵢ for the i^{th} application in the recommended tree. Optimization is achieved by calculating the dᵢ so as to maximize Expression 1, assuming that λ<1. Other Objective Functions may be used in the invention which may then require different optimization processes.

Optimization Iterations

The Objective Function can be optimized in many ways, depending upon the function chosen, and upon various computational objectives. A preferred technique of the invention is to iteratively recompute Expression 1 for all dᵢ while comparing each value of Expression 1 to the others in order to identify the set {dᵢ} corresponding to the maximum value of Expression 1. The optimization engine begins with the reduced generic tree, setting all dᵢ values accordingly. From those expressions all bᵢ are calculated from the μᵢ according to Expression 1. The probability of selecting the i^{th} alternative is then:

pᵢ=vᵢbᵢe^{-λdi} Expression 3

In one preferred embodiment sorting is used to reorder and a “perturbation analysis” technique is used to promote, where variations in the function being optimized are analyzed for single level promotions of the elements highest probability in each list. The Reordering of each list is done by simply sorting entries so that the elements of highest probability are highest on the list. The value of the sum of pᵢ is then computed for later comparison against other sums. Then the highest probability alternative of the first list of first topmost list is Promoted to the topmost list and the value of the sum of pᵢ is recalculated. If it is greater than the last calculation, it is retained. Otherwise it is discarded. Then the item is returned to its former position and the next item on the list is promoted to the level above, and placed just before the list to which it belongs in the level above. The value of the sum of pᵢ is recalculated and retained if it is greater than the previously retained calculation, or discarded if not. The calculations continue until all promotions have been tried at all levels to obtain the maximum sum of pᵢ. The tree corresponding to that maximum is then the recommended tree until modified by some other transformation.

Multiple μᵢ

More than one estimated mean, μᵢ, may be stored for each application. Several real-time attributes are stored with these usage statistics, some of which are used to distinguish between different values of μᵢ for the same i^{th} application. For example, the selection of a particular application by a particular user may differ with the time of day, geographic location, and other parameters that change in real time. For instance, consider a user who is businessperson based in Sausalito, Calif. and who uses an application that organizes business addresses. When that user is in a geographic location distant from Sausalito, say in Los Angeles, the user may be more likely to need the address application during the business day and less likely to need it in the evening hours, and even less likely to need it when at the home base in Sausalito. The value of μᵢ for the address application can then be adjusted according to the user's location and time of day to reflect that the user might select that application with high probability in the morning in Los Angeles, but with lower probability in the evening in Los Angeles, and hardly at all in Sausalito, be it morning or evening.

More stable data that does not normally change often may also affect the user's selection probability. A collection of personal information on each user, generally referred to as the user's profile, is maintained by the platform and is accessible to the optimization engine. The profile may contain a large data set for each user, which may include the user's address, place of employment, gender, personal features, personal preferences, and several other facts pertaining to that particular user. The user's personal preferences are options that the user is able to choose explicitly through menus provided by the platform. The context processor 18 can filter the reduced tree by applying rules inferred from the profile. For example, the optimization engine will automatically elevate the probabilities of Italian restaurants for a user who has declared a personal preference for them.

Adaptability

One parameter belonging to the profile controls the adaptability of all μᵢ for the user. Through that parameter, the user is able to set the Optimizer to be more or less sensitive to optimization. The optimization can be desensitized in several ways. A preferred way is to require, at the end of the optimizing iterations, that the new maximum exceed the previous maximum by some threshold established by the adaptability of the user. Below that threshold, the current tree structure prevails, even though optimization has identified a new tree structure corresponding to a sum of dᵢ having a greater maximum value.

Anchor

The optimization engine further reduces keystrokes to make selections by providing an exploratory mode in which the user can pause at any element, mark it with an anchor, and then begin a search of some other branches of the tree. The user is free to navigate the other branches in the normal way, perhaps selecting an end alternative. However, the user is provided a keystroke which returns to the anchor as if the exploratory search had never taken place. The anchor reduces keystrokes by allowing the user to shortcut to the anchor alternative rather than to enter all of the keystrokes necessary to navigate to that anchor point.

The Reduced Generic Tree

Before estimating the means μᵢ, context processor 18 may transform the generic tree into the reduced generic tree according to the group and segment of the user. Both are abstract terms that can be given meaning by the operator and the application provider through business rules. For example, a user may belong to the group of men over 21 years of age and, at the same time, belong to a group of house owners. Independently, the same user may belong to the western segment, meaning that he lives in one of the states considered to be western. The difference between groups and segments is mostly in usage, with groups generally being more narrowly defined than segments. Another set of business rules may then operates on the groups and segments. The generic tree can be filtered to produce only those end alternatives marked for the groups and/or segments to which the user belongs. For example, a business rule declared by an application provider might state that the application is only to appear to users, “If in Group 1 or Group 3 and not in Group 7.” A change in group or segment need not be made in real-time, as soon as the change takes place, but may wait for a general periodic update in which other parameters are also updated at the same time.

By contrast, the generic tree can be reduced by real-time content filters which effect the user's expressed constraints in real-time. For example, the subscriber may wish to see restaurants within a five-mile radius of their current location. This location will not be known except in real time. Real-time content filtering takes the form of Boolean expressions defined on attributes of the alternatives listed in the content. Although the filters are invoked in real time, they must be registered by the application with the scenario manager before they can be used. Each filter will typically contain parameters whose values will be specified at the time of invocation. The following basic operators are supported:

AND, OR, NOT, GT (for >), GTE (for >=), LT (for <), LTE (for <=), EQ (for =).

The result of applying a real-time content filter to a generic tree is to eliminate substructures that are excluded by the filter constraints.

Advertisement and Promotion

The invention provides commercial slots, places in the navigable structure where commercial messages can be situated. Through the use of slots, the application providers are able to introduce advertising and promotional messages to the user in the normal navigation of the reduced tree. Advertising appears as unusual selections, located as declared by the application provider. The selection may not cause navigation to occur if only the presentation has value to the advertiser. A slot can be related to some other list or application by a business rule provided by the advertiser. The advertising Slot appears only as long as the optimization engine is instructed in real time, by platform 12, to repeat for the next user. For example, the platform may count the number of times the advertisement appears, and price the service accordingly. By contrast, the promotional slot is an elevation of an existing application to a higher structural level of smaller distance. Promotions generally remain in place until withdrawn by the platform.

Context Correlation

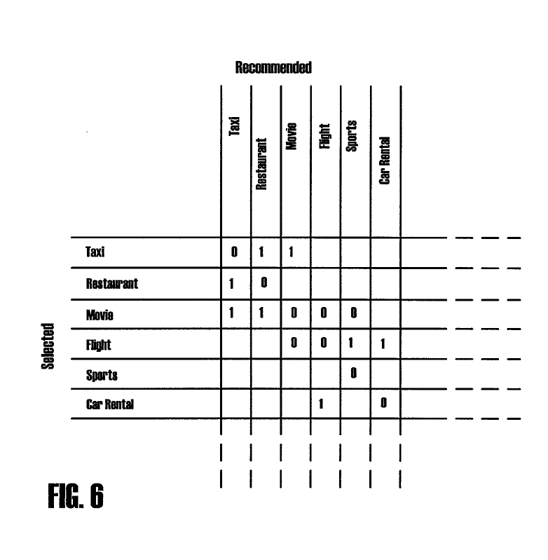

Context processor 18 assembles a correlation list based upon the current selection, the history of selections leading to the current selection, and a correlation matrix which contains the correlation between the lists. The platform then displays the list as a recommended starting point for the next selection sequence after the user has signaled the completion of the current selection sequence by selecting an application. The correlation between two applications is represented as a probability that the user will select the second application after having selected the first. For example, a businessperson might have a high probability of reserving a rental car after having reserved an airline flight. FIG. 5 illustrates the assembly of a correlation list from a recommendation tree. The four entries in the list correspond to the four most likely correlated lists after the user has selected an application from the flights list. The probabilities of the four items use the same Bayes Estimation formulation and Objective Function as do the μᵢ. However, other approaches may be used, including other objective functions and estimators that are not Bayesian.

The probability of each list to be recommended for a correlation list is estimated as a sum of the conditional probabilities of all lists in the sequence of lists that might be selected in the process of selecting the application. Expression 4 shows an example for the probability of “taxi” appearing in the correlated list:

P(taxi/“all paths”)=P(tax/flight)+αP(taxi/travel)+α²P(taxi/reserve)+•••, Expression 4

where P(i/j) is the conditional probability that the i^{th} list will be selected if the j^{th} list has been previously selected. The meaning of the abbreviation “all paths” is the sum of all paths to arrive at the “taxi” list. Several totally independent or partially collinear paths are possible because the easily pictured “tree” is not usually a tree structure at all, but rather a graph of multiply connected nodes, which is more difficult to picture. The coefficient α is a parameter of the model chosen to raise the computed conditional probability by past selections, but rapidly diminish the effect with the number of clicks separating the past selection from the recommended list. Expression 4 is a preferred example on the basis of some of its mathematical properties. However, these probabilities may not be computed on the basis of Expression 4, but on some other formulation having different properties, should some other formulation be considered preferable.

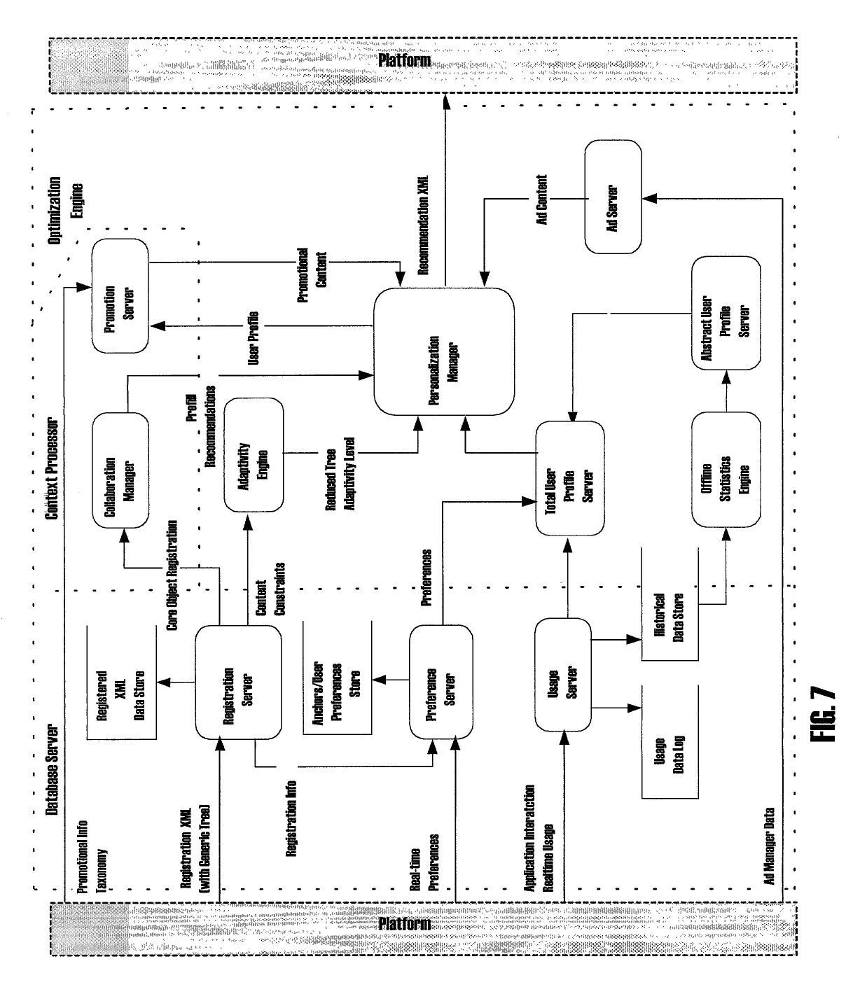

The P(i/j) are represented by the correlation matrix, a Markov matrix of conditional probabilities which the context processor updates in real time whenever the P(i/j) are recalculated. One preferred method to calculate the conditional probabilities is to use the same optimizing function as is used to calculate the μᵢ. The correlation matrix is initialized from the initializing correlation matrix illustrated in FIG. 6. The logical user's interface, or LUI, according to the invention provides a user-friendly graphic interface with which the application provider can enter parameters and rules that declare commercial intentions and biases. Initializing parameters are among those that may be entered. To initialize the correlation matrix, the application provider marks a matrix cell with “0” if there is never to be a correlation, and with “1” if a correlation is initially forced between the two paths. For example, if the user is never expected to reserve an airline flight after just searching for a movie to see, then the matrix element (Movie, Flight) is set to “0” by an application provider. Conversely, if the user is expected to order a taxi after making reservations at a restaurant, then the matrix element (Restaurant, Taxi) is set to “1” by an application provider. A matrix element with neither value is interpreted as a “don't care” value, meaning that the correlation between the two lists is established by the conditional probabilities of the context processor. The value begins as zero but, in contrast to the elements marked “0,” the value can be changed by the context processor.

Intelligent Data Sharing

To further reduce the keystrokes, clicks or spoken words, required of the user, the invention provides for sharing data between applications to reduce the number of times that the user must enter a lengthy sequence of keystrokes. When lengthy data, such as a mailing address, is requested of the user by the currently selected application, and that same data had been entered previously to some other application, the invention offers the user a list of recommended prefill data objects that might contain the previously entered data. The user can fill in a field of the requesting application by selecting the required data item from the recommended prefill list rather than entering it anew. This form of data sharing is referred to here as implicit application collaboration, or just collaboration, because applications effectively collaborate in satisfying the user's requirements without explicitly causing the collaboration to occur. The object types and other information used in collaboration are obtained from the user by the LUI. Each application provider must provide registration information to become known to the operator. That information contains the specific data needed by the invention to cross-match object types and relevancies.

For example, someone might use a cell phone to reserve a table at a restaurant. The user might then order a taxicab for transportation to that restaurant. The taxicab application will need to know both the pick-up and drop-off addresses, each of which could consist of 40 or more keystrokes. However, both addresses are known by the context processor. The user's own address appears on the prefill list because it is known from the user's profile. The restaurant address appears on the prefill list because of collaboration. It was previously entered as part of the registration process of the restaurant application. The user responds to the taxicab application requests by selecting the user address from the recommended prefill list to fill in the pick-up address, and the restaurant address to fill in the drop-off address. The context processor then provides the data objects to the requesting application as if they had been entered directly by the user.

The context processor can infer that a pick-up address is a data object of the “mailing address” type, regardless of its name, because the type is declared during the registration of every application. Similarly, the user's address is declared as a mailing address in the user's Profile. The use of object types is critical because mailing address data objects can have different names in different applications, for instance “home address,” “residence address,” “customer's address,” “mailing address,” and others. The context processor can recommend all as “mailing addresses” because all were declared as that type by the applications when registering. In addition to matching type, the list can be reduced, by the context processor, according to the constraints of business rules based upon the location of the user, the time, and other factors. The alternatives are displayed as alternatives of a list from which the user can select the appropriate object. The complete data represented by the selected alternative can then be provided to the requesting application as if it were entered directly by the user.

Idioms

The keystrokes required by an application can be reduced by substituting previously used sequences for a single alternative, just as previously entered data can be referenced as one alternative by intelligent data sharing. The scenario manager provides a reference, referred to as an idiom, that represents a sequence of selections frequently made by a user while using a particular application. Instead of selecting each step in the sequence individually, the user can select the idiom, for which the scenario manager substitutes the specifications representing the sequence. For example, in a banking application, the user might be asked to first select the kind of transaction (for instance “account transfer”), then the account to transfer from (for instance “savings”), and finally the account to transfer to (for instance “checking”). If the user tends to make this sequence of selections regularly, a significant reduction in keystrokes is provided by a single option which specifies “transfer money from savings to checking”. The scenario manager maintains statistics on the applications clickstream and provides the appropriate specifications on request by the Application.

Object Oriented Architecture

The benefits of Object Oriented Design, or “OOD,” are well known and are well suited for use in implementing the invention. The Java programming language brings those benefits to the invention but also goes beyond to those well known additional benefits of Java. Among them, the interface concept in Java is particularly beneficial for implementing the invention because of the need for reusability and understandability of the products based upon the invention. The invention can be used by software developers who do not modify the products based upon the invention but only interface to them. For that reason, the preferred embodiment of the invention provides API that pass XML blocks, as well as API that are documented Java interfaces.

FIG. 7 is a dataflow diagram of a preferred embodiment of the invention. The rectangles of rounded edges are major Java classes. Many more classes exist that are not shown on the diagram because they are used by the classes of the diagram, or because they are occupied with administrative and other tasks that are not germane to the main concepts of the invention. The square rectangles open at the right represent relational database tables or other storage structures. The dashed rectangles at the two ends of the diagram represent the Platform. Data flows from the Platform at the left, through the classes of the invention, and out to the Platform at the right. The groupings of classes in FIG. 1 are enclosed by dashed lines in FIG. 7 and labeled “Database Server,” “Context Processor,” and “Optimization Engine.”

FIG. 7 makes reference to, but does not show, a group of classes referred to as core objects. These classes describe objects which form the basic building blocks of many commonly used mobile applications. For example, the core could include a DateTime class, a Location class, a Telephone class, a Person class, etc. The scenario manager does not have any domain knowledge since application semantics best reside in the application. However, the system does associate limited semantics with core classes where impracticable to ignore. Every core object used by an application must be registered if it is to participate in intelligent data sharing between applications. Registration is the process by which an application simply provides the system a unique id for each core object being used along with its class.

In FIG. 7 some references are made to real-time information. Another descriptive name for real-time information is on-line information, both terms meaning preference information that is pertinent to a particular user and provided by the Platform during the time that the user is being served by the scenario manager. For example, real-time content filters need to have information on the user's preferences of the moment, such as the user's constraint that only restaurants within five miles of the user's current location are of interest. The user's anchor is another example. Real-time information of this kind is passed from the Platform to the Preference Server Class, of FIG. 7, which in turn stores it in the database and passes it, on request, from the database to the Total User Profile Server Class of FIG. 7. The Preference Server Class also provides off-line preference information to the Total User Profile Server Class. The term “off-line” refers to that information that is passed from the Platform whether or not some specific user is on-line. Such information is updated on a periodic basis, for instance daily.

All data from the Platform, except for advertising and promotional information, passes from the database server in the Platform to the database server of the invention. The input referred to as “Registration XML” includes the greater part of the data used by the invention. It includes the generic tree, implemented as an XML block, and all personal data for each individual user, represented as an XML block for each user. The Registration Server Class stores the data of the Registration XML block in a standard relational database such as an Oracle product. The generic tree remains in XML representation.

The complete user's profile is constructed from several sources. Usage information from the Platform is logged and preserved in the Historical Data Store by the Usage Server Class. It includes the clickstream and Core Objects relevant to the selected application. A complete history of each User's activities can be reconstructed from the Historical Data Store. The Offline Statistics Engine references the Historical Data Store to compute the statistics for each User. They are computed off-line, and do not change during the User's active Scenario so that the recommendation tree does not reorganize itself in a confusing way for the User. User statistics can be recomputed on a daily basis. The Abstract User Profile Server Class provides only the information pertinent to the Recommended Tree. The Preference Server Class is able to retrieve Registration information through the Registration Server Class. The Total User Profile Server Class can then assemble the complete user profile by retrieving the user's on-line and off-line preferences and personal Registration information from the Preference Server Class, the application and usage information from the Usage Server Class, and the pertinent statistics from the Abstract User Profile Server Class.

The Personalization Manager Class in FIG. 7 constructs the recommended tree, an XML block, as a final processing of information from other classes within the optimization engine and from the context processor. The user profile is provided by the Total User Profile Server. The reduced tree is provided by the Adaptivity Engine Class which obtains the generic tree and constraints from the Registered XML Data Store through the Registration Server Class. It applies the constraints to the generic tree to obtain the reduced tree. The Collaboration Manager Class executes the intelligent data sharing on the core objects used by applications and produces the prefill recommendations, for the given user, that replace the recommendation tree while the user is interacting on-line with the application.

The two remaining sources of information for the Personalization Manager are concerned with advertising and promotion. They derive data directly from the Platform through API used by the Service Operator or Advertiser. The API of the Promotion Server Class requires the promotional information such as the content and business rules for associating the promotion with specific User selections. From that, the Promotion Server Class provides the Personalization Manager Class with the specifications necessary for accommodating the promotion in the recommended tree. A similar processing of advertising data is provided by the Ad Server Class to the Personalization Manager Class so that it can transform the recommended tree to accommodate the Advertising Slot.

The recommended tree is then produced by the Personalization Manager Class and passed to the Platform as an XML block.

The above descriptions and drawings are given to illustrate and provide examples of various aspects of the invention in specific embodiments. It is not intended to limit the invention only to these examples and illustrations. Given the benefit of the above disclosure, those skilled in the art will generally be able to devise various modifications, alternate constructions and alternate implementations for different types of electronic devices and different situations of use that although differing from the examples disclosed herein nevertheless enjoy the benefits of the invention and fall within the scope of the invention, which is to be defined by the following claims.

What is claimed is:

1. A method for presenting an optimized selection of alternatives from a plurality of alternative choices to a user through an electronic device, comprising the steps of:
providing a statistical model for said plurality of alternative choices, said statistical model reflecting user-specific and non-user-specific weighting factors;
applying said statistical model to a first ordered selection of choices to derive a recommended selection of choices of optimized order, said optimized order being determined by said statistical model; and
presenting said recommended selection of choices to said user substantially in said optimized order.

2. The method of claim 1 wherein access to said plurality of alternative choices is provided by a service operator and said method further comprises the step of including in said statistical model a weighting factor reflecting preferences of said service operator in presenting alternatives to said user.

3. The method of claim 2 wherein at least one of said alternative choices is provided by a third-party advertiser and said method further comprises the step of including in said statistical model a weighting factor reflecting preferences of said third-party advertiser in presenting alternatives to said user.

4. A method for presenting an optimized selection of alternatives from a plurality of alternative choices to a user through an electronic device, comprising the steps of:
providing a statistical model for said plurality of alternative choices;
applying said statistical model to a first ordered selection of choices to derive a recommended selection of choices of optimized order, said optimized order being determined by said statistical model;
presenting said recommended selection of choices to said user substantially in said optimized order for further selection of an end alternative by said user;
when said end alternative calls for entry of data by said user, applying said statistical model to derive a recommended selection of prefill data objects; and
presenting said recommended selection of prefill data objects to said user.

5. A method for presenting an optimized selection of alternatives from a plurality of alternative choices to a user through an electronic device, comprising the steps of:
providing a statistical model for said plurality of alternative choices, wherein said statistical model is an Empirical Bayesian statistical model;
applying said Empirical Bayesian statistical model to a first ordered selection of choices to derive a recommended selection of choices of optimized order, said optimized order being determined by said statistical model; and
presenting said recommended selection of choices piecemeal to said user substantially in said optimized order.

6. A method for presenting an optimized selection of alternatives from a plurality of alternative choices to a user through an electronic device having a display capable of showing only a characteristic number of choices to the user at a time, comprising the steps of:
providing a statistical model for said plurality of alternative choices;
applying said statistical model to a first ordered selection of alternative choices to derive a recommended selection of alternative choices of optimized order, said optimized order being determined by said statistical model; and
presenting at least a portion of said recommended selection of alternative choices to said user a fixed number at a time substantially in said optimized order, said fixed number being at most the characteristic number said device is capable of displaying at a time.

7. The method of claim 6 wherein said statistical model reflects both user-specific and non-user-specific weighting factors.

8. The method of claim 6 wherein said statistical model is an Empirical Bayesian statistical model.
